(19) United States
(12) Patent Application Publication
(10) Pub. No.: US 2006/0016728 A1
(43) Pub. Date: Jan. 26, 2006

(54) Particle separation

(76) Inventor: Graeme Stewart Shorts, Bournemouth (GB)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/514,406

(22) PCT Filed: May 16, 2003
(86) PCT No.: PCT/GB03/02124

§ 371 Date: Jul. 14, 2005

Related U.S. Application Data
(60) Provisional application No. 60/381,023, filed on May 16, 2002.

(51) Int. Cl. B03B 13/00

(52) U.S. Cl. 209/1

(57) ABSTRACT

A laminar or cyclonic particle separator for gas, liquid-liquid and fluidizable solids separation comprised of a section with a non-metallic housing having an annulus and a chamber, an optional anode cooled with a first coolant in and a first coolant out disposed in the chamber, a DC or pulsating DC power source connected to the anode, at least one magnetic coil disposed adjacent the chamber and cooled with a second coolant, a high voltage pulsating DC power source connected to the magnetic coil, and a fluid (gas, liquid or fluidizable solids) inlet port connected to the housing, and also a section with a non-metallic separator tube connected to the housing and disposed within the housing, a first fluid outlet connected to the annulus through the housing. This device can then separate a stream rich in a targeted element (first fluid) and a stream lean in a targeted element (second fluid) from the device and thus discharge a stream almost free of the targeted element or almost 100% the targeted element.

### FIELD OF THE INVENTION

The present invention relates to methods and apparatuses for separating gases, liquids or fluidizable solids or separating multiple or discrete ions, compounds, or elements from gases, liquids or fluidizable solids by generating magnetic fields.

The term ‘fluid’ will be used herein to include, where the context admits, liquids, gases and fluidised solids.

The invention also relates to magnetic field devices as applied through magnetic resonance imaging (MRI) and other imaging applications, such as nuclear magnetic resonance imaging (NMRI).

The magnetic fields desirably have highly uniform field strengths and directions (dipole fields), uniform radial gradients of the field strengths within the body of the device (quadrupole fields), or sextupole, octupole, and above fields within the body of the device that are generally uniform.

Uniform and higher order electric field gradients have application in the separation of components of liquids or gases with different dielectric constants, or separation of components with different electric dipole moments whether electric field induced or permanent, such as metal particles in a gas or fluid, ions or salts in solution, or different atomic weight compounds, or water dispersed in oil.

### BACKGROUND OF THE INVENTION

Present devices for generating uniform magnetic fields in relatively large volumes are of three basic types: resistive solenoid magnets, super conductive solenoid magnets, and permanent magnets. Each device has significant drawbacks. Conventional resistive magnets are handicapped by limited field strength (approximately 0.2 T), cooling requirements, power consumption of 50 kW or more, high inductance which makes pulsed operation impractical, and the generation of substantial fringe fields in MRI applications.

Conventional superconductive magnets, while providing for high fields (0.5 T to 2 T), have the disadvantages of high cost, need for complex cryogenic systems that are expensive to operate, high inductance (cannot be pulsed), generation of substantial fringe fields.

Permanent magnets have lower fringe fields and good patient access, but have low magnetic fields (less than 0.1 T), are not adjustable in field strength, cannot be pulsed, and are very heavy (typically more than 12,000 pounds for a 0.064 T system).

An extremely important use of uniform magnetic field generation is MRI diagnostic procedures. They have not traditionally been used for liquid-liquid separations, semi solids and not for desalination of salt water.

MRI systems employ a strong constant uniform magnetic field (usually 0.3 T to 1.5 T) to align the magnetic dipoles of proton nuclear spins. These aligned dipoles are then tipped out of alignment by a radio frequency pulse. The constant applied field attempts to force the spinning dipoles back into alignment and they precess around the field direction, much like a gyroscope. This coherent precession and spin relaxation produces a radiated signal that is analysed to produce an image. The actual process is more complicated, using field gradients and a variety of signal processing methods. In all systems, the image quality depends critically on the homogeneity and stability of the applied magnetic field.

The disadvantages of present MRI systems centre primarily on the high-field magnet required and its external effects. MRI systems are expensive, with a high-field (1.5 T) system costing about $1,500,000.

Much of the total cost of the facility, however, is due to site requirements pertaining to effects of the magnet's field on external objects and the effects of those objects on the magnet. A need has long existed for a low cost and practically portable MRI system, which can be used for a wide variety of separations.

The present invention stems from some work to provide devices and methods for generating uniform pulsating high frequency magnetic fields that reduce or eliminate the disadvantages of present systems listed above.

Embodiments of the invention use a relatively small number of inductors that are situated parallel to the long axis of a non magnetic (the process tube) conduit or tube. These inductors are of a determined inductive length, internally cooled, their electrical lengths are isolated only by the close coupling of the cooling system. The fluid to be separated is passed along the tubes axis into a diminishing (concentrating) diameter, at the critical focal point the pulsed lines of force are introduced, they are directed through the mass of the fluid and to an anode. This anode can serve three purposes it serves as a frequency multiplier, a directional path amplifier, and a guide path for the separated fluids.

### SUMMARY OF THE INVENTION

According to one aspect of the invention we provide a particle separator for separation of first and second mixed fluids, as hereinbefore defined, comprising a non-metallic housing containing an annular through-flow chamber, an inlet to the housing for introduction of a mixture of the first and second fluids into said through-flow chamber, a portion of said through-flow chamber being encircled by a magnetic coil, an anode located in said chamber portion, coil cooling means for cooling the magnetic coil by means of a first coolant, a cooling conduit extending through said chamber portion and adapted to cool said anode by means of a second coolant, a high voltage pulsating DC power source connected to said magnetic coil, a further DC power source connected to said anode, fluid separation means positioned downstream of said through-flow chamber portion to receive energised fluid mixture that has been subjected to the magnetic field created by pulsing of the magnetic coil, the fluid separation means being so arranged as to separate the first and second fluids from the energised mixture.

According to a second aspect of the invention, we provide a method of separating a selected component from a mixture of fluids, as hereinbefore defined, comprising introducing the mixture to a chamber and subjecting the mixture in a portion of the chamber to a magnetic field created by subjecting a liquid-cooled coil encircling said chamber portion to DC voltage pulses of characteristics chosen to energise the selected component of the mixture, and whist the selected component remains at least partially energised, using a separation means which is adapted to divert the energised components to a different outlet from that to which relatively unenergised components of the mixture pass.

One embodiment of the invention is a laminar element particle separator for gases, liquids and fluidizable solid separation comprised of a lower and upper section of tube. The lower section is made of a non-magnetic housing having an annulus and a chamber, and at least one inductive magnetic coil disposed adjacent to the chamber which is working in a coordinated conjunction with an inductor anode concentrator that is enclosed within the tube, and centered to the flow of the targeted liquid or semi-liquid. The external inductor coil is cooled with a non-conductive coolant, and the anode inductor is internally cooled. A high voltage modulated pulsating DC power source connected to said inductive magnetic coil and in conjunction with this pulsing an anode attraction frequency modulated voltage is applied to its corresponding anode. The fluid inlet port connected to the housing arranges the inlet targeted material in flow. The upper section is also a non-metallic separator tube connected to the housing and disposed within the housing, a first fluid outlet connected to the non-metallic separator tube and a second fluid outlet connected to the annulus through the housing.

Another embodiment of the invention is a cyclonic particle (element) separator for gas, liquid, or fluidizable solid separation. The cyclonic element particle (element) separator is made of a non-metallic housing with a chamber (which can be a separate component) has at least one magnetic coil disposed adjacent the chamber and cooled with a coolant, a high voltage modulated pulsating DC power source connected to said magnetic coil and an excitation current is applied to one or more eternal anodes, with at least one many more cyclonic separator's disposed in the chamber or out of the chamber and wherein the cyclonic separator has a fluid inlet, and brine (non desirable components) outlet, a cyclonic separator freshwater (desirable components) outlet, and a freshwater outlet fluidly connected with the cyclonic separator freshwater (desirable components) outlet.

The invention has many uses and embodiments as a separation device for gases, liquids, and fluidizable solids. Seawater separation, which is currently more developed, is used as an example to explain the principles of the invention and how it works for seawater. The same principles can apply to all the mentioned mediums with some modifications and minor adjustments in design.

The invention is also a method for particle (element) separation. The method entails using a tube and a magnetic coil disposed as an anode shaped device. Seawater (as an example) is directed into the chamber and out of a brine outlet and a freshwater outlet while simultaneously energising the magnetic induction coil. Freshwater is created in the chamber, then freshwater is flowed near the tube and, then is attracted into a separator tube, using the Coanda effect. Finally, the freshwater is directed by the anode from the separator tube into the freshwater outlet.

The invention is also a cyclonic method for element particle desalination. The method involves using a tube and a magnetic coil disposed in a chamber, flowing seawater into the chamber and out of a brine outlet and a freshwater outlet, and simultaneously energising the inductive magnetic coil, creating freshwater in the chamber; using cyclonic forces to maintain a separation between the freshwater in the chamber and the seawater flowing into the chamber, and flowing the freshwater near the tube and attracting the freshwater into a separator tube, and flowing the freshwater from the separator tube into the freshwater outlet.

The invention also contemplates that the cyclonic particle separator can have an electromagnetic shielding system disposed around the separator.

The invention also contemplates a laminar method for atomic particle desalination. The method entails the following steps, a) using a tube and a magnetic coil disposed in a chamber or optionally, the tube is a cooled anode, b) flowing seawater into the chamber and out of a brine outlet and a freshwater outlet, c) simultaneously energising the tube, or cooled anode, d) this energisation can be for only a few seconds to freshwater in the chamber, e) next, the freshwater is flowed near the tube or anode using the Coanda effect and attracting the freshwater into a separator tube; and f) finally, flowing the freshwater from the separator tube into the freshwater outlet.

A variation on the preferred laminar method is wherein the energising step comprises using at least one pulsating frequency to create at least one pulsating magnetic field that matches the atomic frequency of at least one salt being separated.

In another variation of the laminar method is where the plurality of discrete atomic frequencies of materials are matched through a sweep of the discrete frequencies using a magnetic field at the discrete frequencies in turn. The matching step can also be performed using a magnetic field using discrete atomic frequencies.

In another variation of the laminar method, the freshwater flows through the separator tube using the Coanda effect.

The invention in another aspect contemplates a cyclonic method for ionic particle desalination. The cyclonic method involves the following steps, a) using a tube, or cooling an anode with a cooling fluid, and a magnetic coil in a chamber, b) flowing seawater into the chamber and out of a brine outlet and a freshwater outlet, c) simultaneously energising, such as for a few seconds, the tube or cooled anode and the magnetic coil, d) creating freshwater in the chamber, e) using cyclonic forces to maintain a separation between the freshwater in the chamber and the seawater flowing into the chamber, and f) flowing the freshwater from the cyclonic separator outlet into the freshwater outlet.

A variation on the preferred cyclonic method is wherein the energising step comprises using at least one pulsating frequency to create at least one pulsating magnetic field that matches the atomic frequency of at least one salt being separated.

In another variation of the cyclonic method is where the plurality of atomic frequencies of materials is matched through a serial energisation of discrete frequencies using a magnetic field. The matching step can also be performed using a magnetic field at discrete atomic (NMR) frequencies.

The present invention is for an apparatus and method for generating an electromagnetic field for the separation of materials in a fluid stream, comprising: a central axis; providing a conductive pathway, disposed about and substantially parallel to the central axis, an electromagnetic field, passing a fluid through the field, and removing the separated matter from the fluid.

It is an object of the invention to provide useful apparatus for certain applications including separation of metal from mine slurries, desalination of ocean water and other separations.

The invention can enable not only the targeted element or compound to be removed but some related compounds may also be removed using a discrete or multiple frequencies.

The invention can be used with minor modifications to handle the materials involved to make many chemical, biomedical, food and other separations that are considered either impossible or extremely expensive by other available methods.

The invention may be used for the separation of mixed gases to do either bulk separation or to remove small quantities of selected impurities. This would provide a lower cost lower energy alternative to currently available processes.

The inventive processes may be operated continuously or operated batch wise to produce small quantities of separated or high purity materials.

The invention can enable separation of fluidizable solids on a single or progressive batch wise basis using manual to fully automated methods.

In one embodiment an apparatus comprises a plurality of separators which are batch fed on a sequential basis so as to provide an effectively continuous operation.

The invention can enable the targeting of one or more ions or elements in a semi-solid mixture for removal, at greatly reduced cost in many cases, often using much less energy than is possible using conventional methods. Solids separations will greatly reducing the pollution potential of the process compared to currently available processes.

The primary advantages of the uniform magnetic field embodiments of the present invention are that the user incurs negligible exposure to the magnetic fields when the separator is provided with suitable external electromagnetic screening.

Discussion of Prior Art Separation Technoligies

Desalination Technologies have traditionally included certain Thermal Processes, such as the following:
1. Distillation, which includes heating, evaporation, and condensation. It is a process where seawater is heated to produce steam. The steam which is then condensed to produce water with a low salt concentration.
2. Vapour compression, in this process, the heat is provided by the compression of vapour rather than by direct heat input from a boiler.
3. Multi-stage flash distillation, this distillation process that utilizes the concept that when water enters a low-pressure chamber, some of it rapidly boils, or flashes, into water vapour.
4. Multi-effect distillation, this distillation process that is different than the multi-stage by using preheated salt water, spraying it onto evaporator tubes to promote rapid evaporation.

Desalination has also occurred with a Membrane Process.

Membrane separation (Reverse Osmosis) works by forcing seawater through a semi-permeable membrane, which restricts salt and other minerals, but allows water molecules to pass through. It requires the use of high pressures which inevitably involves high costs.

Electro-dialysis is also a membrane a process in which an electric voltage is applied across a saline solution that causes ions to migrate through a membrane toward the electrode that has a charge opposite to that of their own.

Freeze thaw technology is also used to desalinate seawater where the water is partially frozen and the concentrated brine is decanted and the purer frozen water is recovered and reprocessed as required to produce desalinated water.

Hydropcyclones are a third known separation technique but only work to remove solid mater.

A hydrocyclone is generally used as a separation device to separate solids from a liquid. The underlying mechanism utilizes centrifugal forces, which greatly accelerate the speed at which particles settle under the force of gravity, so it can be closely related to gravity separation equipment and to sedimenting centrifuges.

Centrifugal force is an apparent force associated with an object moving on a curved path, such as a ball on a string. The force that constrains the ball to move on the circular path is referred to as centripetal force, while the force that pulls on the string in an outward direction is centrifugal force.

Gravitational force is referred to as the average force of earth's gravity on earth's surface. Gravity is commonly measured in terms of acceleration that the force imparts to an object on earth.

In solid/liquid hydrocyclones, suspended particles denser than the suspending liquids tend to migrate toward the outside, while those less dense moves toward the centre. The rapidity with which the migration proceeds depends on the intensity of the centrifugal field, the difference between the density of the particle and the suspending liquid, the viscosity of the liquid, the size and shape of the particle, and to some extent, the concentration of the elements and the degree to which they are electrically charged.

The shape of the hydrocyclone usually resembles that of a cone. The feed stream is tangentially injected into the top of the cone. Acceleration of a feed stream entering a hydrocyclone is achieved through the combined effects of the tangential inlet and the injection of the feed under pressure. The higher the pressure and smaller the cone, the higher velocity and the higher the centrifugal force to augment the movement of the particles (elements). The injection of the feed generates a flow along the inner surface of the cyclone body, known as the primary vortex flow. The primary vortex, with its relatively low centrifugal forces, causes the denser or heavier particles (elements) to settle along the outside of the wall, or “apex”, and exit the underflow end of the body. The smaller or lighter particles (elements) remain towards the centre, or “vortex”, to be drawn up toward the top and exit from the overflow orifice. In the centre, both the circumferential speed and the angular velocity are much higher than along the outer shell of the hydrocyclone, thus generating higher centrifugal forces, which forces the less dense particles (elements) out of the overflow end.

Hydrocyclones have long since been used as a method of separating solids from liquids, solids from gas and gas from liquid. Only until recently have hydrocyclones been used for liquid-liquid separations. This is because the separation of two liquids is much more difficult than other separations due to relatively low-density differences between fluids as compared to the separation of solids or gasses, which have relatively high-density differences.

Magnetic separation is another known technology for removing matter from fluid, and for continuously purifying sea, river or reservoir water. Magnetic separators use differences in the magnetic susceptibilities of particles to produce a force that is greater on particles with a greater magnetic susceptibility. The force that is produced places the particles at different positions and allows separation to occur. Magnetic separators use ferromagnetic bodies that attract or repel magnetic particles, while the nonmagnetic particles are dispersed in the opposite direction therefore allowing ease of separation.

Ionic species separation involves the separation of ions and impurities from electrolytes.

Electrophoresis is another known separation technology. A mixture of ionic species is exposed to an applied voltage field, which causes the ions to migrate toward the oppositely charged electrode at a rate that depends on their electrophoretic mobility, which in turn depends on charge, mass and symmetry as well as other parameters. In other words, electrophoresis is the movement of electrically charged particles in a fluid under the influence of an electric field. Particles in electrophoresis technologies are separated by differing electrokinetic mobilities. When a sample's charged components have different electrokinetic mobilities they migrate at different rates and physically separate because of their differing electrokinetic mobilities.

For convenience, in comparing the technology provided by the present invention with known technologies, the technology of the present invention will be referred to herein as ‘APS desalination technology’ or as ‘APS’.

Ion Cyclotron Resonance, hereinafter referred to as ICR, is a technology that can be compared to the APS Desalination technology, although gaseous ions contained within plasma are being separated. In ICR, it is well known that a moving gaseous ion, or a charged particle, in the presence of a uniform magnetic field describes a circular trajectory in a plane perpendicular to the direction of the magnetic field, and is unrestrained in its motion in directions parallel to the magnetic field. The frequency of this circular motion is directly dependent upon the strength of the magnetic field and the charge-to-mass ratio of the ion. When such orbiting ions are subjected to an oscillating electric field disposed at right angles to the magnetic field, those ions having a cyclotron orbital frequency equal to the frequency of the oscillating electric field absorb energy from the electric field and are accelerated to larger orbital radii and higher kinetic energy levels. Ions having a cyclotron frequency substantially equal to the frequency of the oscillating electric field are said to be resonant with the electric field. Since only the resonant ions absorb energy from the oscillating electric field, they are distinguishable from non-resonant ions upon which the oscillating electric field has substantially no effect.

Plasma separation that utilizes centrifugal forces is also comparable to APS. Plasma centrifuges operate in accordance with a few well-known physical principles. In short, a plasma centrifuge generates forces on charged particles, which will cause the particles to separate from each other according to their mass. Whenever a charged particle is placed in an environment wherein a magnetic field is crossed with an electric field, the charged particle will be forced to move in a direction that is perpendicular to the plane of the crossed fields. In addition, charged particles will tend to travel through a magnetic field in a direction that is generally parallel to the magnetic flux lines. For configurations wherein the electric field is radially oriented perpendicular to a central axis, and the magnetic field is oriented parallel to the central axis, the charged particle will be forced to move along circular paths around the central axis. This circular motion, however, generates centrifugal forces on the charged particle that will cause the particle to also move outwardly and away from the central axis. Because the magnitude of a centrifugal force acting on the charge particle is a function of the mass of the particle, it follows that, for a given condition (ie for given crossed electric and magnetic fields), high-mass particles will experience higher centrifugal forces than low-mass particles.

Isotope separation of plasma uses the following principle: if a group of ions is subjected to a magnetic field and an oscillating electric field perpendicular to the magnetic field, then those ions having an orbital frequency in resonance with the frequency of the electric field will absorb energy from the electric field. This causes the resonant ions to accelerate to a larger orbit and those with different frequencies do not; some patents utilize the increased orbit to complete a separation in a centrifuge and some do not.

There are many patents that relate to the desalination of water. However, since technologies such as Reverse Osmosis and Distillation are known technologies, many patents are improvements on existing technologies. Below is a list of patents that disclose a method and/or apparatus to remove salt from a saline solution. These patents do not relate to APS and APS is very different from these patents. It should be noted that many other similar patents that disclose desalination systems exist.

The following patents disclose a method and/or apparatus to remove salt from a saline solution and are hereby incorporated by references: U.S. Pat. Nos. 5,160,634, 3,963,567, 4,036,749, 6,217,773, 4,772,385, 6,132,613, 5,094,758, 6,074,812, 4,891,140, 6,083,382, 4,141,825 and 4,118,299.

The following ionic species patents are noted and incorporated by references: U.S. Pat. Nos. 5,858199, 5,425,858, 5,647,969 and 4,008,135.

The following patents disclose known magnetic separation of liquids and are incorporated by references: U.S. Pat. Nos. 4,054,513, 4,190,524, 4,663,029, 4,664,796, 4,961,841, 5,466,574, 5,565,105, 5,568,869, 5,759,391, 5,944,986, 6,093,318, 6,207,463 and 6,182,831.

The following patents use radio frequency, RF pulses to excite targeted material and are incorporated by references: U.S. Pat. Nos. 5,153,515, 5,572,126, 4,695,798, 5,804,967, 5,619,138 and 5,448,170.

Safe drinking water and water used for agricultural purposes is vital to the health of citizens in every community all over the world. This necessity of water and the limited supply of usable water make it a very valuable resource and commodity. Water covers about two-thirds of the Earth's surface, so it seems paradoxical to say that water resources are running low, but that is the reality that we face today. The amount of usable water in the world is limited. This is because most of the water that covers the world is too salty or too contaminated for use. Only approximately 2.5% of the world's water is not salty, and two-thirds of this relatively small amount is locked up in the icecaps and glaciers of Antarctica and Greenland. The amount of freshwater available for human use is less than 1.0% of all the water on the planet. Most of the time, the remaining fraction of freshwater that fills the earth's lakes and rivers is enough to supply human needs. However, with population increases and industry and agricultural demands, freshwater resources are quickly becoming scarce. Therefore, water scarcity is quickly becoming a global concern as more countries' freshwater sources are becoming depleted.

It is conservatively estimated that the world's demand for water is growing at a rate of 5% to 7% per year. The World Water Council report estimates that in the next two decades the use of water by humans will increase by about 40%, and that 17% more water than is available will be needed to grow the world's food. According to the World Water Council, more than one billion people lack access to clean drinking water and some two and a half billion do not have adequate sanitation services. This translates to one person in five across the world that do not have access to safe and affordable drinking water, and one in two that lack safe sanitation. These types of statistics have countries looking for alternatives to produce potable water. The APS desalination technology was created to provide such an alternative.

Many solutions have been proposed to solve the potentially devastating water shortage problem. Solutions such as water conservation programs and devices and new reservoirs have been developed but these solutions are only short-term solutions. Conservation techniques and water storage are both limited by current water resources. Conservation cannot solve a problem such as a freshwater resource becoming dry or too contaminated. In the future, technologies will have to be developed that solve any future water shortages by producing new freshwater sources. Water shortages may be the result of events such as droughts, contamination, salt-water intrusion, or limited water sources, even after conservation methods have been implemented. So where does the world look to solve these problems? One way to produce potable water is to tap into the largest source of water, the sea. Thus, the world is very interested in technologies that produce potable water from seawater.

Desalination, also known as desalinisation, is a water treatment process that removes salt, other minerals or chemical compounds from impure water to produce potable water. The two predominantly used technological approaches used worldwide in commercial desalination are distillation and membrane separation. Multi-Stage Flash is the predominant distillation process that accounts for approximately 71% of the total installed desalination capacity from all sources while Reverse Osmosis accounts for approximately 19% of the total installed desalination capacity. These two processes make up approximately 86 percent of used technologies while the remaining 14 percent is made up of multi-effect, electrodialysis and vapour compression.

Reverse osmosis works by forcing seawater is heated to produce steam, which is then condensed to produce water with a low salt concentration and few of the other impurities contained in the original water. APS technology is very different from both of these processes.

Distillation works well but requires large quantities of heat energy, and costs have been prohibitive for nearly all but the wealthiest nations, such as Kuwait and Saudi Arabia. This method does not require the use of large amounts of energy and can be considerably cost effective.

Reverse Osmosis does offer energy savings because it uses pressure to push freshwater from saltwater. However, the permeable membranes have relatively short life spans and are highly susceptible to contaminants in the source water, particularly chlorine and fine silt. The membranes tend to become “fouled” or “scaled” over time by organic and inorganic substances present in the water. Although new and improved membranes such as the thin composite membrane are being introduced to help solve such problems, APS will not have equipment that introduces these types of problems to the desalination system. Another problem with Reverse Osmosis that APS will improve upon is the process's use in places like the Middle East and the Gulf of Mexico. Gulf water has more salt than ocean water, therefore making desalination more difficult to complete. In addition, the warm Gulf water reduces the useful life of the membranes.

Certain characteristics about desalination make it an extremely costly technology. Capital investment and operations are expensive for all desalting options because pipes and equipment require corrosion-resistant materials, while special pre-treatment filters and cleaning membranes require frequent backwashing to remove the rapid accumulation of silt. In addition, chemicals must be used in the pre-treatment of the source water and de-fouling chemicals such as acid must be used to prevent scaling in reverse osmosis systems from seawater. Organic fouling is also a problem if the seawater is not disinfected and is directly pumped into the plant. However, cost effective methods of disinfection usually damage the membranes and the excess disinfectant must be removed prior to the Reverse osmosis membranes. Reverse osmosis requires high pressures up to 75 bar requiring mechanical energy for pumping the water up to high pressures. Chemicals used to clean the system and solid wastes generated from the process must be disposed of properly. The APS Desalination technology can provide a unit that does not require as much maintenance as conventional desalination units because it has considerably less equipment than a reverse osmosis unit to produce potable water. Thus, due to its simple construction, the installed cost of the APS unit will often be significantly less than the equivalent reverse osmosis unit. The APS Desalinisation technology can operate at minimum currents (milliamps). The APS unit can tolerate small amounts of silt and low cost oxidizing biocides such as chlorine. The APS unit can also require much less energy than reverse osmosis since the feed pressure can be 1 to 4 bars compared to 28 to 75 bars.

The efficiency of desalination is between 15-50%; in other words, 15-50 gallons of potable water are produced for every 100 gallons of seawater.

The remaining unusable water consists of brine and dissolved solids, which are disposed of in one of the following five ways: (1) direct discharge into the ocean, (2) combining the waste with sewage treatment plant wastewater or with power plant cooling water before discharging into the ocean, (3) drying brine to make salt or disposing in land fills, (4) underground injection, (5) discharging into a sewer for treatment by a sewage treatment plant (for brackish water systems only). This discharge of unusable brine can have a damaging environmental effect directly impacting things such as marine wildlife, plants and water quality. One advantage of the APS Desalination technology is that it can allow for additional extractions of particles in the remaining liquid. A particular chemical species can be selected and extracted using APS because of the different resonance frequencies of element and compounds that are established by nature. APS is able to tune its system to a certain frequency and remove the particles resonating at a particular frequency. Thus, APS allows for a sequential selective removal of dissolved components from seawater and this could be valuable and beneficial for other uses. When discharging the leftover liquid, the impact on the environment is not as great as when using conventional desalination techniques.

Estimates for desalinated water run from an optimistic $2.00 or less per 1,000 gallons up to several times that amount depending on the cost of electrical power. However, as technology improves, the cost of desalination is going down but it is still too high for most agricultural uses to make economic sense. It should be noted here that agriculture is by far the largest consumer of water. Many countries utilize more than 70% of their water resources for agricultural purposes. The high price of agricultural water requires governments to subsidise the process. Subsidisation is done to provide water, food or jobs but it also has negative consequences. Users do not value water so they waste it. Furthermore, the subsidies do not end up with the poor but are captured by the rich. Therefore, water conservation technologies do not spread and too few investment funds and revenues are available to maintain water infrastructure, research, and training systems. In addition, the average family ends up paying over three times as much as farmers do for a cubic meter of water. The purpose of this invention is to create a process that will be cost effective. With this invention, the price of agricultural water will be low enough so a country can avoid subsidising water. Once subsidisation of water to its greatest consumer, agriculture, doesn't exist, a nation's water supply will be dramatically stretched out.

### DESCRIPTION OF THE INVENTIVE TECHNOLOGY

The principle embodiments of the present invention combine NMR principles with centrifugal forces or natural laminar flow for division of first and second fluids, such as freshwater from brine, in conjunction with magnetic attractions and rejections to separate the first and second fluids, such as particles (elements) dissolved in a liquid.

This combination of techniques can greatly enhance for example the desalination process, which can make the separation more efficient than other liquid/liquid separations. NMR is used to cause molecular excitation and subsequent freeing of molecules from their confining yokes. By using NMR, APS is able to selectively excite materials (elements and ions) and thus is able to separate said elements including associated ions and some other ions to a lesser extent from a solution. Applying a pulsed field charge in such a way that once applied, it leaves a charge that has an ongoing effect for a limited period of time, which is subject to flow and magnetic pulse rate. If the pulse is properly applied, it can save energy and be considerably cost effective.

Embodiments of the invention provide a process that utilizes the scientific principles of atomic particle magnetic resonance and hydrocyclone technology, or laminar flow principles combined with the Coanda, to effect separate targeted contaminants from seawater in order to produce potable water.

One main application of the invention is in the desalination field but it also applicable to many other separation technologies including most gas, liquid/liquid and fluidizable solids separations.

This invention uses the field of Nuclear Magnetic Resonance (NMR) and hydrocyclone technology or hydraulic separation to provide a system for separation of one or more particles from a mixture. The system is a batch or continuous system where the NMR principles are first applied to a liquid, which is then pumped through a hydrocyclone, or laminar flow separator, that provides the necessary division of separated ion species, elements or ions.

This invention utilizes the absorption of energy of selected components in order to weaken the molecular structure of materials to be separated. In addition, using NMR enables APS to selectively excite materials to be separated. Pulse sequences similar to ones used in the MRI field are used to selectively excite the targeted materials in the APS technology. The lengths of the pulses are desirably kept small such that the pulses can be considered as ‘needle pulses’. The pulses may be of length 2 μs for example.

To begin the process given by this inventive technique, targeted materials in a solution are subjected to high intensity magnetic field. The magnetic field is given by a high frequency pulsed field charge via wire coils surrounding a solution container, ie the energiser tube. To explain what is occurring a snap shot in time is taken viewing a section of the energiser tube and the targeted material that is suspended in the fluid that is being sent through the energiser tube. In this particular example, our snap shot is confined, to the area of the main energiser tube and that part of the tube that is being subjected to the described unique magnetic field pulse, its applied timing rate, the liquid controlled flow rate, and the overall effect caused to the said targeted material. The condition of the applied field causes molecular excitation and the subsequent freeing of the molecules from their confining yokes. The energiser tube also introduces its own cyclone effect causing rotation of the particles similar to a centrifugal effect. Thus, by utilizing gravitational separation, particles will be pre-separated by atomic weight, further preparing the magnetic cyclones or laminar separators to complete the separation. In addition, the energising tube can be fitted with its own horizontal separation bands that feed the magnetic cyclones 1 to 5 or more with the material that is to be separated. Therefore, the cyclone can be fitted with an internal manifold that will accommodate five multiple cyclone separators with the deflection and attraction inductor.

It is important to note that molecular excitation only occurs in materials whose natural resonant frequency is equal or near to the frequency of the applied pulsed field. This is according to the principle of NMR, where it is known that a chemical species whose precessional frequency resonates with a high frequency magnetic field absorb energy from that alternating magnetic field (giving bands of colour). Therefore, this invention allows for the individual selection of any particle contained within a chemical composition. Furthermore, the freeing of molecules from their confining yokes prepares the targeted materials for separation.

This applied pulse along with all the other complementary magnetic pulses that form part of the APS process are synchronized for the maximum impact with that of their targets. Therefore, their stability has to be within three, or preferably more, decimal places. The amplitude of the main system pulses is very high thus ensuring that the desired field strength is at the focal epicentre. The width, amplitude, duty cycle and phasing of the said pulses are such that they are extremely narrow and of great amplitude and are actuated only as required, thus to give maximum energy to the pulse and to preserve the accumulated source of power required to drive the said pulse. This type of pulse also ensures that the desired material is selected and excites only the material to be separated and does not excite materials with neighbouring resonance frequencies.

If a number of different resonant targets are to be separated then the applied line frequency is not simply in a swept order, but its own unique individual frequency is fired with its very own set of characteristics in a sequential order.

The field effect once applied does leave a charge that has an ongoing effect for a limited period of time, which is subject to flow and pulse rate. The ratio of the charge to flow rate can vary as much as 100:1. If properly applied energy can be saved and the device can be considerably cost effective.

After being subjected to the applied pulsed field given by the primary inductor around the energiser tube, the targeted in-flow material is in a confused but free state. The targeted material can then be subjected to a secondary inductor further down the flow path of the energiser tube to improve the speed and separation effectiveness. This inductor applies a positive charge to the targeted material in flow, which prepares it for the separation that takes place within the hydrocyclone or laminar flow separator. The hydrocyclone is equipped with two separate coils at the top and bottom of the device that provide magnetic fields. The coil positioned at the top of the cyclone is a tuning device that is similar to the primary inductor around the energiser tube. Its purpose is to further weaken the molecular bond of the targeted materials. The coil at the lower end of the cyclone applies a negative or rejection charge. The purpose of this is to attract the positively charged targeted materials to the narrow portion of the cyclone and out the underflow end. The combination of centrifugal forces inside the cyclone and the attraction of the particles to the lower portion of the cyclone are the basis for the separation. The magnetic field created by the inductor will attract positively charged particles for exit out of the underflow end and reject negatively charged particles for exit out of the overflow end of the cyclone. The negatively and positively charged particles are not the normal negative and positively charged particles found in saline water but particles that are separated and are not separated due to their atomic resonate frequency. This is the same principle that applied to an Inductively Coupled Plasma analyser known as ICP analysis. The ICP analysis depends on separating the natural resonant frequencies of compounds to be analysed and reads the resulting frequencies and strength allowing analysis to parts per billion. Using this same principle the resonate frequencies are applied instead of generated causing the separation of the desired ions.

Two fluid streams of processed water exit the magnetic cyclone apparatus (the combined single or multiple cyclone separators), one that is rich in the targeted material and one that is relatively free of the targeted material.

The source pump supplies salt water to the manifold input. Three or more coarse filters are placed in line to the manifold to enable replacement if the seawater is practically dirty. The pump is controlled conventionally using modern or archaic process control and its power is supplied from the available local electrical supply source. The available local power gives various voltages and current levels in AC and DC power to support the main computer (optional), the main pulse device/devices, the pulse energy for the separation water circuit, the d/c excitation for the water circuits and the master oscillator/clock and wave shaping circuits. The method of obtaining the proper pulse and wave form to the electromagnets and coils can and will vary as the science of electronics advances and has changed considerably in the past couple of years. Process control is by the use of conventional flow, conductivity, and other appropriate online testing as required to assure adequate water quality at all times. This control can also be done on a batch wise basis using conventional wet lab analysis or on an on-line basis.

All targeted material is fed from the sea source into, and then from, the main pump or pressurized seawater source. It is routed through the inlet manifold into the primary main separation tube. The initial pulsed field charge is presented to the flowing material via the primary inductor.

Another purpose of the main energiser tube is to introduce its own cyclone effect. This causes rotation of the mass more of a centrifugal effect, which through gravitational separation by atomic weight prepares the magnetic cyclones for their own individual, but selective tasks. At this point it is possible to divide the separated phases using laminar or other hydraulic flow principles. The main energiser tube is also fitted with an internal manifold that accommodates five one or more cyclone separators with the deflection and attraction inductors and its inlet nozzle size. It contains its own horizontal separation bands that will feed the magnetic one or more cyclones with their own required material that is for final separation for exclusion or storage.

To continue the explanation: from the primary inductor, the targeted in-flow material is in a confused but free state. The optional secondary inductor applies a positive charge to the targeted material in-flow that prepares it for the separation that takes place within the magnetic cyclone. The inductor shown at the top of the yoke tunes the individual magnetic cyclones. The inductor shown at the lower end in the yoke gives the negative or rejection ion charge. The targeted material that is now in a confused but free state is also polarized and prepared for the attraction and rejection that is performed in the magnetic cyclone. The magnetic cyclones utilize the magnetic fields created by coils and attract or repel ions that are to be separated. The magnetic cyclones also utilize centrifugal forces as a way to enhance the separation process. Finally, the separated solution is split into a lean and rich stream and exits the magnetic cyclones.

The separation can also be preformed using hydraulic flow principles to separate the lean and rich streams before they are able to recombine using laminar flow and possibly the Coanda effect. Finally, the separated solution is split into a lean and rich stream and exits the device.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating the preferred embodiments of the invention and are not to be construed as limiting the invention. In the drawings:

FIG. 1 is a schematic vertical cross-section of a laminar flow separator, in accordance with the invention,

FIG. 2 is a section the line 2-2 of FIG. 1,

FIG. 3 is a section on the line 3-3 of FIG. 1,

FIG. 4 is a front view of the separator of FIG. 1 without the shielding,

FIG. 5 is a schematic vertical cross-section of a cyclonic flow separator in accordance with the invention,

FIG. 6 is a section on the line 6-6 of FIG. 5,

FIG. 7 is a front view of the separator of FIG. 5,

FIG. 8 is a schematic vertical cross-section of a further separator in accordance with the invention used with seawater and incorporating a centrifugal separator unit,

FIG. 8a is a plan view of the centrifugal separator unit of the separator of FIG. 8,

FIG. 9 is a schematic cross-sectional view on the line 9-9 of FIG. 1 to show the magnetic field lines generated by the coil,

FIGS. 10a, 10b and 10c are circuit diagrams of coil and anode energisation circuits in accordance with the invention for use with the separator of FIG. 1, FIG. 10a to be positioned alongside FIG. 10b, (FIG. 10c being an enlargement of the circled portion of FIG. 10b), and

FIG. 11 is a schematic vertical cross-section of a separator in accordance with the invention and suitable for separating material in fluidised powdered material.

### DETAILED DESCRIPTION OF THE PREFERRED EMBODIMENTS

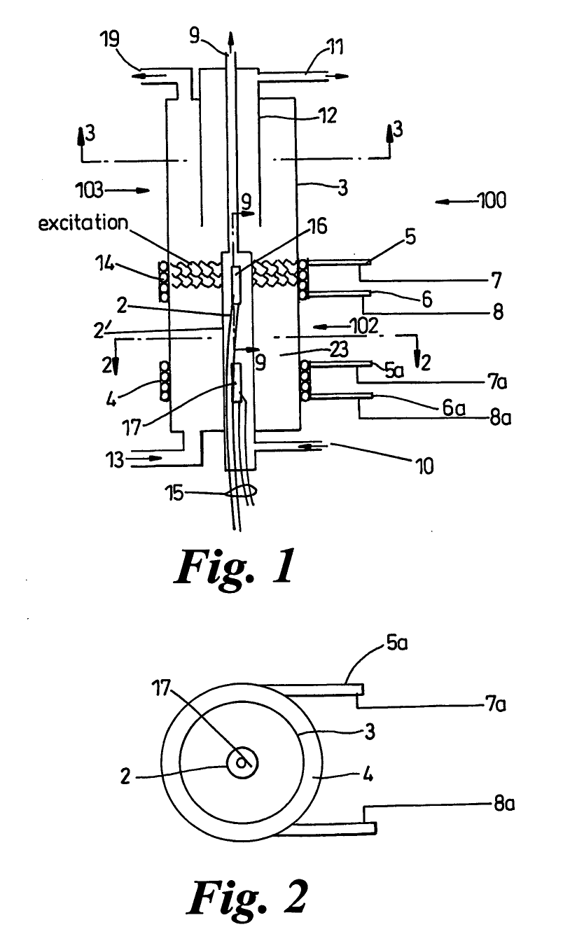

The invention contemplates a laminar particle separator for liquid-liquid separation, and this will be described with reference to FIGS. 1 to 4. The lower section (102) of the laminar particle separator (100) is made of a non-metallic housing (3) with an annulus (23) defined between the wall (2′) of a chamber (2) and housing (3). Optionally at least one anode (16) is located in chamber (2) and is cooled with a coolant that circulates around the anode from a first coolant inlet (10) to a coolant outlet (9) leading from the chamber (2).

The laminar particle separator can use a DC or pulsed DC power source (15), which is preferably pulsating. If the anode (16) is used, the power source (15) is connected to the magnetic coil (14) disposed in the chamber, the magnetic coil (14) being cooled with a second coolant supply. In FIG. 1, a second magnetic coil (4) is also shown wrapped around the housing (3).

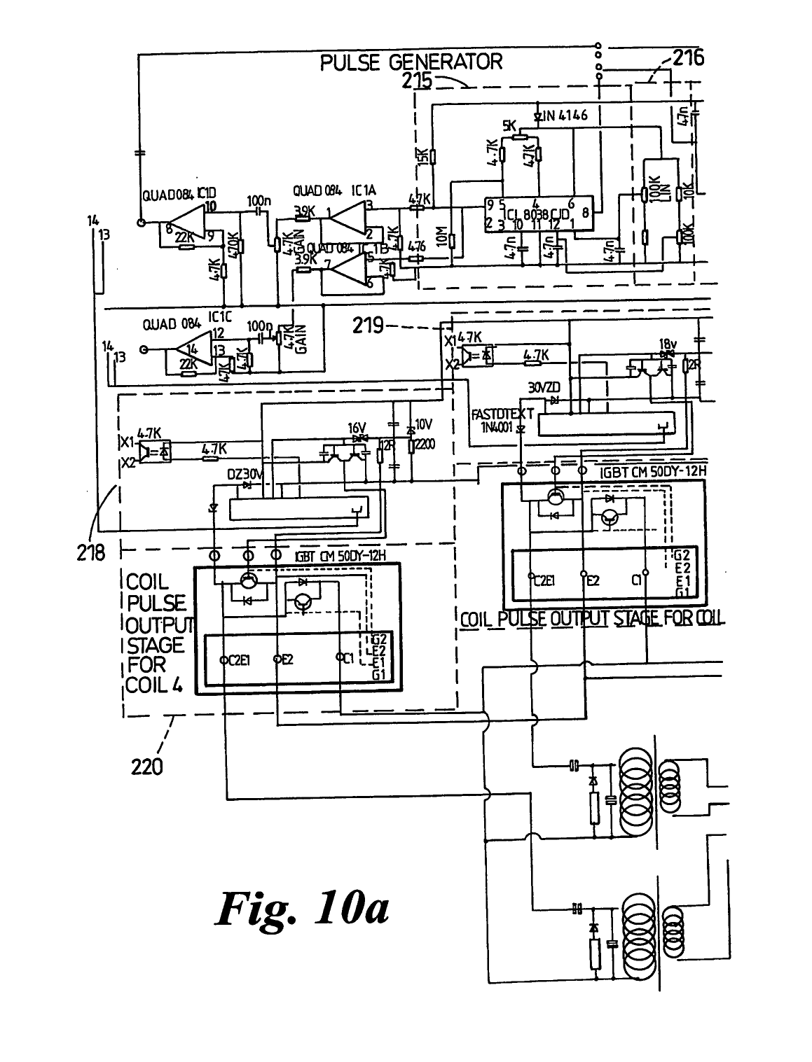

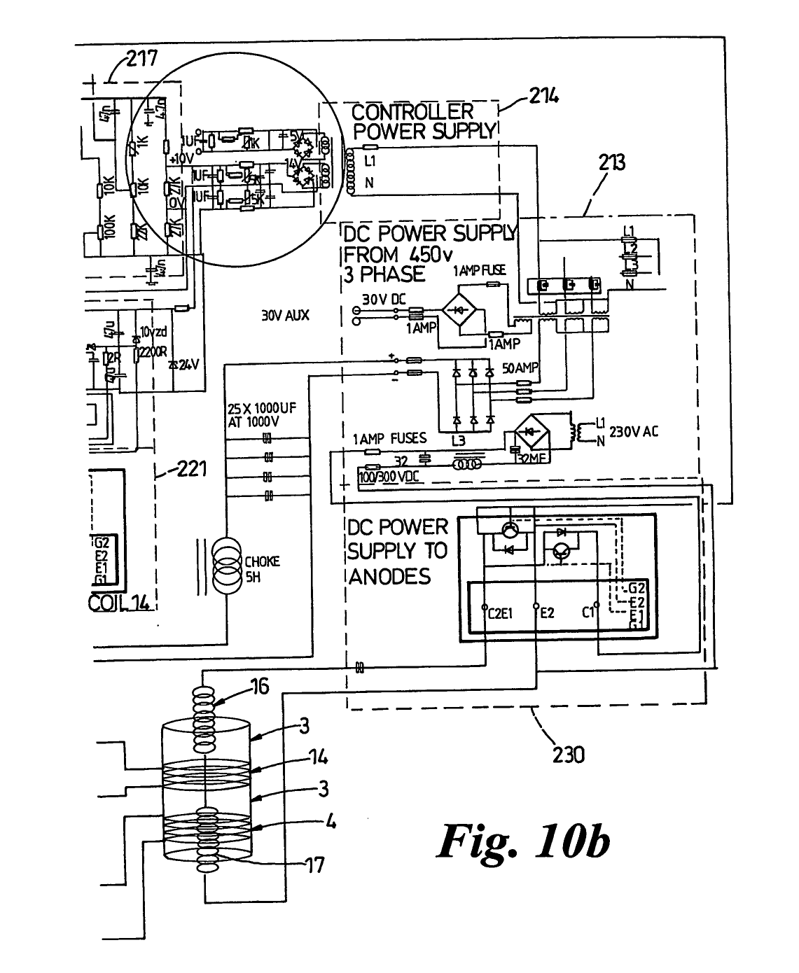

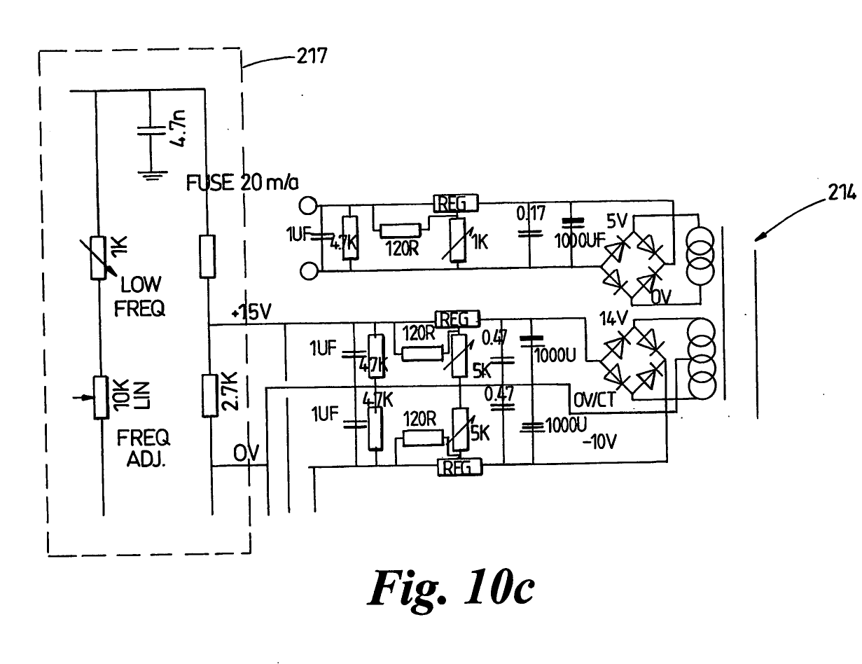

FIG. 1 shows the second coolant streams inlet (5) and outlet (6) of the coil (14). For the second magnetic coil (4), coolant stream inlet (5a) and coolant stream outlet (6a) cool the coil. Further, the laminar particle separator has a high voltage pulsating DC power source, with a positive end (7) and a negative end (8), connected to the magnetic coil (14). A fluid inlet port (13) for the fluid to be treated is connected to the lower end of housing (3). The second magnetic coil (4) also has a second high voltage DC power source associated therewith, with positive end (7a) and negative end (8a), connected to the magnetic coil (4). Details of the DC power supplies will be described hereafter with reference to FIGS. 10a and 10b.

The upper section (103) preferably comprises a non-metallic separator tube (12) extending axially into the housing (3), with a first fluid inlet (11) and a fluid outlet (19) connected to the annulus (23) through the housing (3).

The fluid inlet port (13) can receive seawater, in which case the freshwater to brine ratio should be equal to the cross sectional area of the non-metallic separator tube (12) and the surface area of the remaining annulus (23) of the housing (3) adjacent to tube (12).

FIG. 1 shows a laminar particle separator with two anodes as a preferred embodiment. The anodes, (16) and (17), can be disposed near the axis of the chamber (2). The anodes themselves, (16) and (17), can be tubular, but they may be a solid metal wire with a suitable core, such as a ferrite core or other cores that act like a ferrite core.

FIG. 2 shows the relative positions of the chamber (2), the core (1), non-metallic housing (3), and magnetic coil (4). The second coolant inlet (5), second coolant outlet (6), high voltage DC or pulsed DC power source connections (7) and (8) are shown.

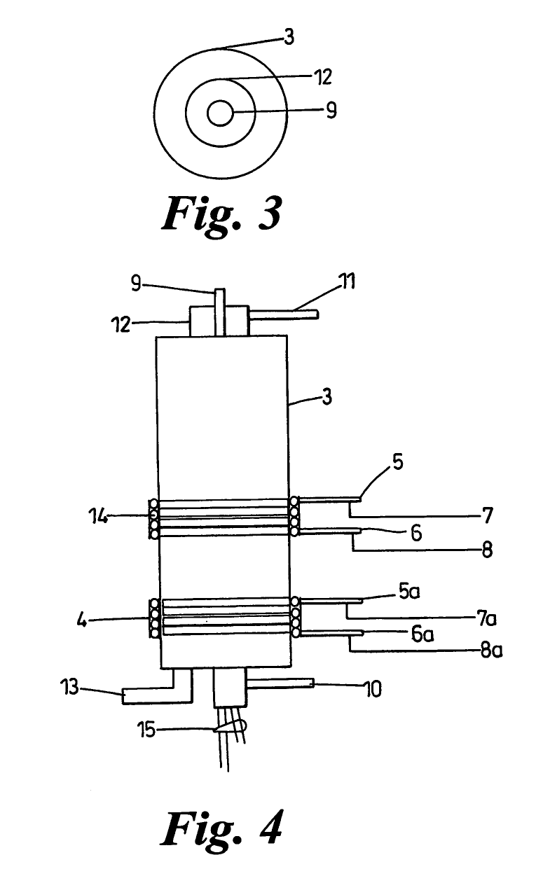

FIG. 3 shows the relative positions of the non-metallic housing (3), non-metallic separator tube (12), and the first coolant outlet (9).

The laminar particle separator's non-metallic housing (3) can be made of glass, polyethylene, polypropylene, polybutylene, polyketone, poly-carbonate, polyvinyl chloride, polyvinyl acetate, ceramic, wood, fibreglass, cross linked polymers, non-cross linked polymers and mixtures thereof. In addition, the non-metalic housing (3) can have a coated interior. The coated interior can be coated with a corrosion resistant material or can be coated with a friction reducing material. The lower section (102) of the housing can be tubular or round.

The laminar particle separator's DC power source can be pulsated to synchronize with the magnetic coil (4). The magnetic coil (4) can also be wrapped around the housing (3) or torridly wrapped around the housing (3). Further, the magnetic coil (4) can be wrapped around the housing (3) in a plurality of individual torridly compressed loops.

The magnetic coil (4) may alternatively be disposed in the chamber (2) separate from the anode (16). In addition, when two magnetic coils, (14) and (4), are wrapped around the housing (3), the magnetic coil (4) can also be disposed inside the housing (3).

The first and second coolants for the laminar particle separator of FIGS. 1 to 3 can be distilled water, glycerine, a dielectric transformer coolant, or mixtures thereof.

FIG. 4 is a front view of the laminar particle separator similar to FIG. 1 where the laminar particle separator does not have a shielding system disposed around the separator. The invention contemplates that the laminar particle separator can be varied to have a shielding system disposed around the separator. The reference numerals for this figure are identical to the components in FIG. 1.

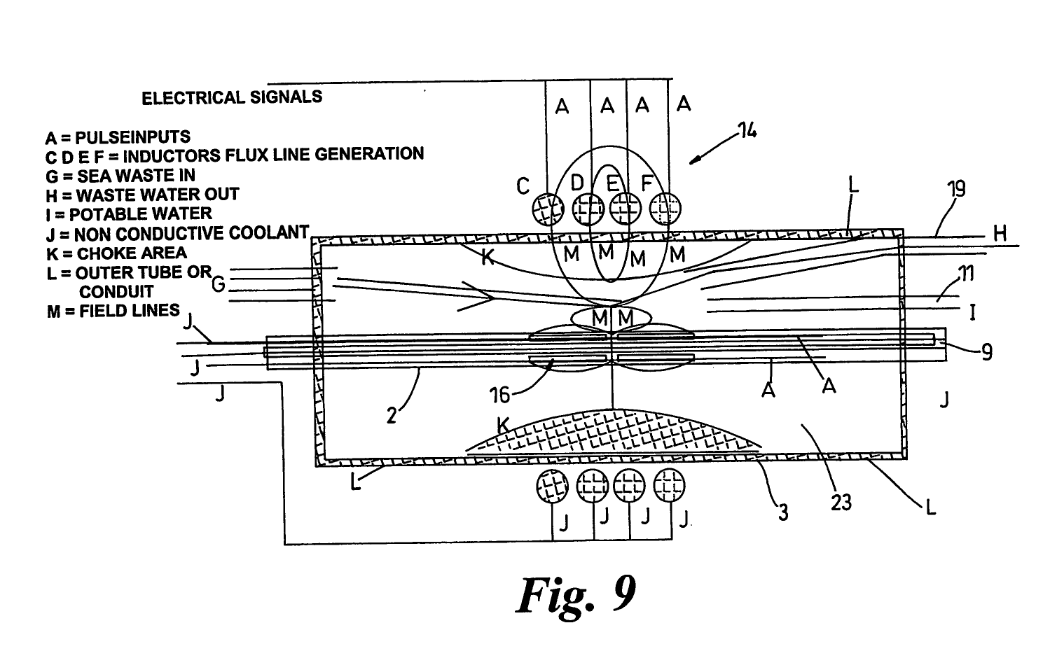

FIG. 9 shows the principles of the inventive separation method. Excitation of the targeted element/s (by which we mean the item/s to be separated) is accomplished by the application of special formed or shaped high energy magnetic pulses forming flux lines that are transmitted through the mass that is being driving through the conduit (3), a non-magnetic cylinder. Around the cylinder or the conduit's circumference is wound the liquid cooled sectionised inductor coil (14) (each section of the coil (14) is cut to a tuned length).

The lines of flux indicated at M are concentrated by being positioned at a choked section K of the tube (3), their strengths amplified by focusing all their efforts toward the anode inductor (16) which is positioned in the centre of the tube's said choked section. The phasing and timing of the pulses applied to the tube's various inductors are critical to each other and also critical to the anode's timed reception which is the cause of the targeted elements amplified resonance.

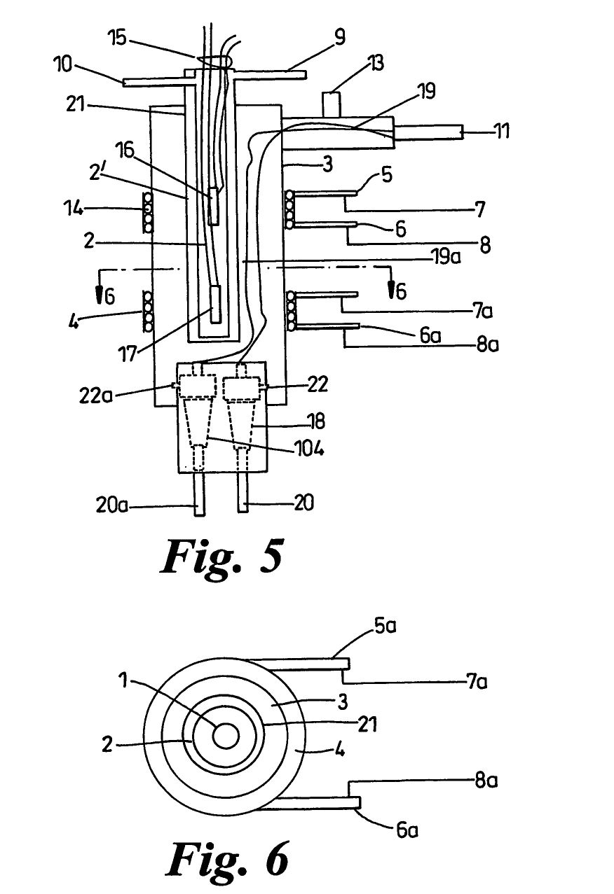

The invention also contemplates a cyclonic particle separator for liquid-liquid separation and an example is shown in FIGS. 5, 6 and 7. The cyclonic particle separator is made of a non-metallic housing (3) and a chamber (2), defined by a wall (2′). The cyclonic particle separator may include at least one anode (16) and, optionally, a second anode (17) disposed in the chamber (2). The anodes (16) and (17) are cooled with a first coolant. The first coolant intake (10) provides an inlet port, and an outlet port (9) is provided to permit the first coolant to flow from the chamber (2). The anode can optionally have a housing (21). If the anodes are used, an optional pulsating DC power source (15) is connected to the anodes (16) and (17).

At least one magnetic coil (14) is disposed adjacent the housing (3) and is cooled with a second coolant that enters from the intake (5) and exits from the outlet (6). A high voltage pulsating DC power source, with a positive end (7) and a negative end (8), is connected to the magnetic coil (14). A second magnetic coil (4) is connected to a second high voltage DC power source, with a positive end (7a) and a negative end and (8a), and cooled with coolant from a second coolant intake (5a) and outlet (6a).

The cyclonic particle separator of FIG. 5 also includes at least one cyclonic separator (18) disposed in the chamber and wherein the cyclonic separator has a fluid inlet (22), a brine outlet (20), and a cyclonic separator freshwater outlet (19). A freshwater outlet (11) is fluidly connected with the cyclonic separator freshwater outlet (19). (The brine inlet (13) and freshwater outlet (19) can be arranged coaxially of one another.) A second cyclonic separator (104) can be disposed in the chamber with a fluid inlet (22a), a brine outlet (20a), and a second cyclonic separator freshwater outlet (19a).

The invention also contemplates other variations of the preferred embodiment of the cyclonic particle separator. One variation is where the freshwater outlet is a tube. Another variation includes the cyclonic particle separator having one or two cyclonic separators, (18) and (104), manufactured by Lakos® of California or similar design. The cyclonic separator can also comprise a plurality of freshwater outlets.

The invention also relates that the cyclonic particle separator's fluid inlet port can receive seawater. The freshwater to seawater, or brine, ratio should be equal to the ratio of cross sectional area of the non-metallic separator tube to the surface area to the remaining annulus of the housing.

FIG. 5 also shows that the two anodes, (16) and (17), can be disposed in the chamber, and can be tubular. The anodes can either be a solid metal wire or a suitable core, such as a ferrite material.

FIG. 6 shows the relative positions of chamber (2), non-metallic housing (3), and magnetic coil (4). FIG. 6 also shows the location of the second coolant inlet (5a) and second coolant outlet (6a), DC power with positive end (7a) and negative end (8a). The outer anode housing (21) can be used to encompass the anode.

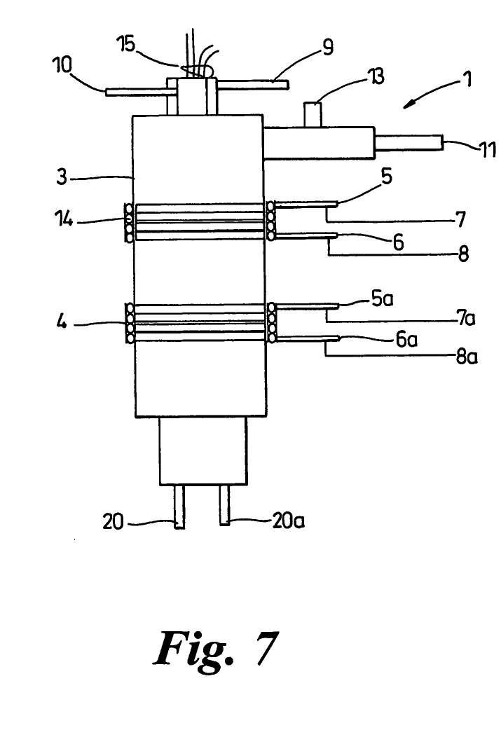

FIG. 7 shows a pulsating DC power source (15) connected to an anode (not shown in this figure). Coolant outlet port (9) and coolant inlet port (10) are shown connected to the housing (3). A brine inlet port (13) is shown adjacent the fluid outlet (11) for freshwater. A first magnetic coil (14) and a second magnetic coil (4) are shown wrapped around the housing. Coolant for the magnetic coil (14) is shown entering through inlet (5) and exiting through the coolant outlet (6). Coolant for magnetic coil (4) is shown entering through inlet (5a) and exiting through outlet (6a). A first brine outlet (20) and a second brine outlet (20a) are shown in this embodiment of the separator.

The non-metallic housing (3) of the cyclonic particle separator can be made of glass, polyethylene, polypropylene, polybutylene, poly-ketone, polycarbonate, polyvinyl chloride, polyvinyl acetate, ceramic, wood, fibreglass, cross linked polymers, non-cross linked polymers and mixtures thereof. In addition, the non-metallic housing (3) can have a coated interior. The coated interior can be coated with a corrosion resistant material or can be coated with a friction reducing material. The lower section (102) of the housing can be tubular or round.

The cyclonic particle separator's DC power source (15) can be pulsated to synchronize with the magnetic coil (4). The magnetic coil (4) can also be wrapped around the housing (3) or torridly wrapped around the housing (3). Further, the magnetic coil (4) can be wrapped around the housing (3) in a plurality of individual torridly compressed loops. The magnetic coil (4) can be disposed in the chamber separate from the anode (16). In addition, wherein two magnetic coils, (14) and (4), can be wrapped around the housing (3). The magnetic coil (4) can also be disposed in the housing (3).

The first and second coolants for the cyclonic particle separator can be distilled water, glycerine, a dielectric transformer coolant, or mixtures thereof.

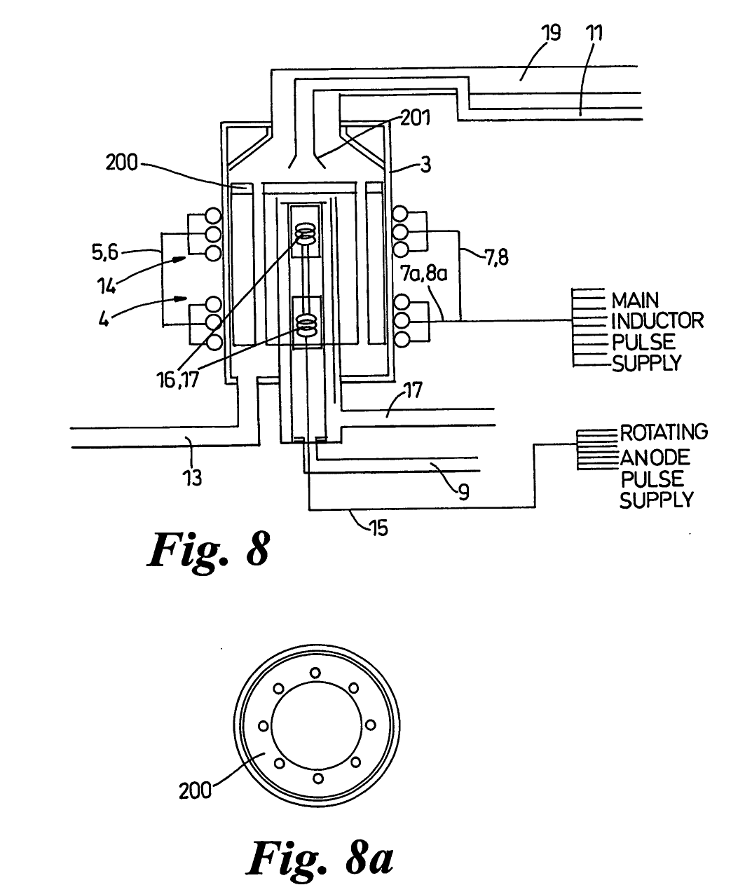

FIG. 8 shows a development of the separator of FIG. 1 incorporating a centrifugal separator unit for separating the targeted ‘element’ just after that element has been energised by the effect of the magnetic fields generated by coils (4) and (14). Parts corresponding to the separator of FIG. 1 have been given corresponding reference numerals in FIG. 8.

The centrifugal separator unit incorporated into the apparatus of FIG. 8 comprises a cylindrical rotor (200). The rotor (200) does not itself rotate but produces a rotating field when the DC pulse to the rotor is synchronised with the pulsing of the magnetic field.

The effect of the centrifugal separator is to cause the high salt concentration part of the flow to be urged radially outwards, whereas the low salt flow, the potable water, is concentrated closer to the axis, and physical separation of these two flows is effected by a central collection funnel (201). The cross-sectional area of the lower end of funnel (201) as compared with the cross-sectional area of the annular space between the funnel lower and the housing (3) is chosen to accommodate the relative proportions of the potable and waste water.

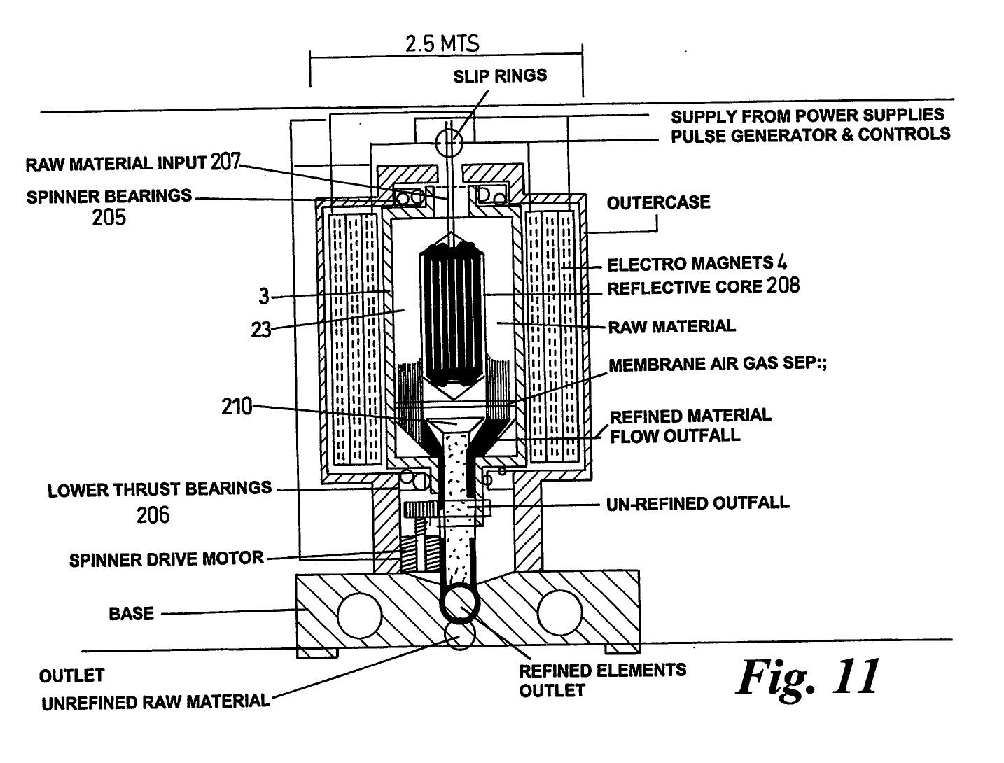

FIG. 11 shows a separator suitable for separating a targeted material, such as a metal powder, from a fluidised powder mixture, such as a powdered mixed material. In order to provide centrifugal separation of the energised targeted material, and to promote flow of the fluidised material through the separator, the cylindrical container 3 is in this case mounted for rotation about the vertical axis in bearings (205, 206). Flow of the fluidised material is downwards from a raw material input (207). Fluidisation is promoted in the usual way by air and vibration. The coils (4) which encircle the container (3) extend substantially for the full height thereof.

In the upper portion of the chamber (23) there is mounted a reflective core (208) in the form of a bundle of tubular elements, and electrical connections to the core are made by way of slip rings (209).

A collection funnel (210) performs a similar function to the funnel (201) of the apparatus of FIG. 8, but in this case it is desired to utilise the material that has not entered the funnel, because the material entering the funnel has had more of the targeted element removed.

An air-gas separation membrane (209) is provided to remove air from the material which is passing to the refined material outlet.

The separator of FIG. 11 can be used in a batch manner, a dwell time being provided between filling and emptying of the separator. In order to provide an effectively continuous facility, a plurality of such separators can be operated in sequence.

FIGS. 10a, 10b and 10c show a preferred embodiment of circuitry for pulsing the coils and anodes of a separator in accordance with the invention, such as the separators of FIGS. 1 and 8.

A 450-volt three-phase stage (212) supplies a DC power supply stage (213) comprising a transformer and rectifiers, the transformer also including winding to a controller power supply 214.

As shown in FIG. 10a, a pulse generator (215) is adjustable by means of a pulse width adjuster (216) and a pulse frequency adjuster (217) FIG. 10b.

The output of pulse generator (215) is adjustable in units (218, 219) which control the firing of the coil pulse output stages (220, 221) for coils (4, 14) respectively, the output stages (220, 221) controlling the high voltage DC output from power supply (213).

The output stages 220 and 221 are separately contained in GBT units. A DC power supply to the anodes (16, 17) is provided by unit (230).

It is preferably arranged that, when a near peak firing amplitude is reached, this on apparent total phase coincidence of a current made by the auto entry to the second anode inductor circuit's frequency doubler, latching occurs such that a self oscillatory mode is set up occurring when the phase angle maximum peaks, corresponding to a super resonance of the target's natural frequency. This phenomenon greatly reduces the amount of energy required to operate the device.

1. A particle separator for separation of first and second mixed fluids, as hereinbefore defined, comprising a non-metallic housing containing an annular through-flow chamber, an inlet to the housing for introduction of a mixture of the first and second fluids into said through-flow chamber, a portion of said through-flow chamber being encircled by a magnetic coil, an anode encircled by said chamber portion, coil cooling means for cooling the magnetic coil by means of a first coolant, a cooling conduit extending through said chamber portion and adapted to cool said anode by means of a second coolant, a high voltage pulsating DC power source connected to said magnetic coil, a further DC power source connected to said anode, fluid separation means positioned downstream of said through-flow chamber portion to receive energized fluid mixture that has been subjected to the magnetic field created by pulsing of the magnetic coil, the fluid separation means being so arranged as to separate the first and second fluids from the energized mixture.

2. The separator of claim 1, in which a pulsating DC power source is connected to said anode;

3. The separator of claim 1, wherein said anode is tubular.

4. The separator of claim 1, wherein the non-metallic housing comprises one of glass, polyethylene, polypropylene, polybutylene, polyketone, polycarbonate, polyvinyl chloride, polyvinyl acetate, ceramic, wood, fibreglass, cross linked polymers, non-cross linked polymers, other non-magnetic materials, or mixtures thereof.

5. The separator of claim 1, wherein the non-metallic housing has a coated interior.

6. The separator of claim 5, wherein the coated interior is coated with a corrosion resistant material.

7. The separator of claim 6, wherein the coated interior is a friction reducing coating.

8. The separator of claim 1, wherein the anode is disposed within and near the axis of the cooling conduit.

9. The separator of claim 1, wherein two anodes are disposed in the chamber.

10. The separator of claim 2, wherein the pulsating DC power source to said anode is arranged to be synchronized with the pulsating DC power supply to said magnetic coil.

11. The separator of claim 1, wherein the pulsating DC power source to said magnetic coil pulses at an atomic resonance frequency so chosen as to match the frequency of discrete ions or elements of said first or second fluid.

12. The separator of claim 1, wherein the first and second coolants are selected from the group: distilled water, glycerine, a dielectric transformer coolant, and mixtures thereof.

13. The separator of claim 1, wherein the magnetic coil is wrapped around the housing.

14. The separator of claim 13, wherein the magnetic coil is torridly wrapped around the housing.

15. The separator of claim 14, wherein the magnetic coil is wrapped around the housing in a plurality of individual torridly compressed loops.

16. The separator of claim 15 in which said loops each comprise arcuate sections each of tuned length.

17. The separator of claim 1, wherein a magnetic coil is disposed in the cooling conduit spaced apart from said anode.

18. The separator of claim 1, wherein two magnetic coils are wrapped around the housing.

19. The separator of claim 1, wherein the magnetic coil is disposed in the housing.

20. The separator of claim 1, wherein the anode is a member of the group: solid metal wire and a suitable core.

21. The separator of claim 20, wherein the metal is electrically conductive.

22. The separator of claim 1, further comprising an electromagnetic shielding system disposed around the separator.

23. The separator of claim 1 in which the portion of the chamber encircled by the magnetic coil is choked so as to diminish the diameter of the annular through-flow chamber.

24. A separator as claimed in claim 1 in which said fluid separation means is a laminar fluid separation means.

25. A separator as claimed in claim 24 in which the laminar fluid separation means comprises a funnel defining a first outlet within the funnel and a second annular outlet external to the funnel, the relative cross-sectional areas of the entrance to the funnel, and the annular space around the funnel entrance being so chosen according to the amount of the targeted element in the mixture to be subjected to separation.

26. A separator as claimed in claim 1 in which the fluid separation means is a cyclonic separator.

27. A separator as claimed in claim 26 in which the fluid separation means comprises two cyclonic separators.

28. A laminar particle separator for liquid-liquid separation comprising a lower section comprising a non-metallic housing having an annulus and a chamber, at least one magnetic coil disposed adjacent the chamber and cooled with a first coolant, a high voltage pulsating DC power source connected to said magnetic coil; and a fluid inlet port connected to the housing, an upper section comprising a non-metallic separator tube connected to the housing and disposed within the housing, a first fluid outlet connected to the non-metallic separator tube, and a second fluid outlet connected to the annulus through the housing.

29. A cyclonic particle separator for liquid-liquid separation comprising a non-metallic housing with a chamber, at least one magnetic coil disposed adjacent the chamber and cooled with a first coolant, a high voltage pulsating DC power source connected to said magnetic coil, at least one cyclonic separator disposed in the chamber and wherein said cyclonic separator has a fluid inlet, and brine outlet, and a cyclonic separator freshwater outlet; and a freshwater outlet fluidly connected with the cyclonic separator freshwater outlet.

30. A laminar method for particle desalination comprising using a tube and a magnetic coil disposed in a chamber, flowing seawater into the chamber and out of a brine outlet and a freshwater outlet and simultaneously energizing the magnetic coil, creating freshwater in the chamber, flowing the freshwater near the tube and attracting the freshwater into a separator tube; and flowing the freshwater from the separator tube into the freshwater outlet.

31. A method of separating a selected component from a mixture of fluids, as hereinbefore defined, comprising introducing the mixture to a chamber and subjecting the mixture in a portion of the chamber to a magnetic field created by subjecting a liquid-cooled coil encircling said chamber portion to DC voltage pulses of characteristics chosen to energize the selected component of the mixture, and whist the selected component remains at least partially energized, using a separation means which is adapted to divert the energized components to a different outlet from that to which relatively unenergized components of the mixture pass.

32. The method of claim 31, wherein said energizing comprises using at least one pulsating frequency which matches the atomic frequency of at least one component being separated.

33. The method of claim 32, where a plurality of atomic frequencies of materials are matched through a digital indexing through specific frequencies using a magnetic field.

34. The method of claim 33, wherein the matching step is performed using a magnetic field using discrete atomic (NMR) frequencies.

35. A method as claimed in claim 31 in which said separation means employs a laminar method for separating two flows of materials, a separator tube being arranged to separate the two laminar flows to direct said flows to different outlets.

36. The method of claim 35, wherein separated material flows through the separator tube using the Coanda effect.

37. A method as claimed in claim 31 in which said separation means employs a cyclonic method for creating two separate flows of materials.

38. The method of claim 31, wherein an anode is located in said portion of the chamber and said anode is simultaneously energized with said magnetic coil.

39. A cyclonic method for particle desalination comprising using a tube and a magnetic coil disposed in a chamber, flowing seawater into the chamber and out of a brine outlet and a freshwater outlet and simultaneously energizing the magnetic coil, creating freshwater in the chamber, using cyclonic forces to maintain a separation between the freshwater in the chamber and the seawater flowing into the chamber; and flowing the freshwater near the tube and attracting freshwater from the cyclonic separator outlet into the freshwater outlet.

40. The method of claim 31 in which the mixture is in the form of fluidized finely ground dry materials.

41. The method of claim 31 in which the mixture is a mixture of liquids.

42. The method of claim 40 in which the mixture is salt water.
